(19) United States
(12) Patent Application Publication
(10) Pub. No.: US 2018/0060663 A1
(43) Pub. Date: Mar. 1, 2018

(54) Augmented Reality Application for Mobile Devices

(71) Applicants: Marc Baskin, Morristown, NJ (US); Zachary Baskin, Morristown, NJ (US)

(72) Inventors: Marc Baskin, Morristown, NJ (US); Zachary Baskin, Morristown, NJ (US)

(21) Appl. No.: 15/687,039

(22) Filed: Aug. 25, 2017

Related U.S. Application Data
(60) Provisional application No. 62/379,389, filed on Aug. 25, 2016.

(51) Int. Cl. G06K 9/00; G06F 17/30; G06T 19/00; G06T 13/80; G09B 19/00

(52) U.S. Cl. CPC G06K 9/00671; G06F 17/30256; G06T 7/60; G06T 13/80; G09B 19/003; G06T 19/006

(57) ABSTRACT

Systems and methods are provided for providing an instruction set to a user for assembling, repairing, or maintaining a manufacturable entity. The method includes utilizing an input device to inspect one or more unassembled parts of the manufacturable entity, recognizing, using the input device, an unassembled part from the one or more unassembled parts, wherein the input device is coupled to an electronic device, determining a correct location and relationship of the recognized unassembled part in relation to one or more of the one or more unassembled parts in a pre-assembled structure, and displaying, on a display, an animation in an augmented reality computing environment demonstrating the relationship between the recognized unassembled part and the one or more unassembled parts, both in regard to each other and to the structure itself.

### CLAIM OF PRIORITY

This U.S. non-provisional patent application claims priority to U.S. Provisional Patent Application No. 62/379,389 filed Aug. 25, 2016, referenced herein in its entirety.

### FIELD OF THE INVENTION

The current invention relates generally to immersive computing, a field of study inclusive of augmented, mixed and virtual reality programs and displays, and image and object recognition, and, more particularly, to display those same objects in an immersive environment based on relationships to each other to the whole, and to the logical or previously published progression of assembly, to be used as an interactive instructional tool for assembling, repairing and maintaining items such as furniture, toys, electronics, appliances and small motor devices.

### BACKGROUND OF THE INVENTION

Many consumers purchase ‘ready to assemble’ products such as furniture, electronics, toys, etc. The assembly of these products is often challenging, and the included instructions are normally inadequate. Online videos exist for some items, but these videos can be hard to follow for more complex assemblies and those with small parts, and it can be difficult to determine nuances, such as differentiating a one inch screw from a three-quarters inch screw in a video.

Currently, the predominant means of accessing instructions sets for consumer-based assemblies (e.g. a bookcase, a desk) is through a published packet that is bundled with said assembly. These packets are comprised of diagrams and pictures, but sometimes lack words so as to provide accessibility to people of all languages. This simplicity in articulating steps to building an assembly also creates a layer of uncertainty and speculation. It is inherently difficult to determine the exact part needed to be utilized and where exactly it needs to be placed from a picture.

Many consumers purchase ‘ready to assemble’ products, such as furniture, electronics, toys, etc. The assembly of these products is often challenging, and the included instructions are normally inadequate. Online videos exist for some items, but they can be hard to follow for more complex assemblies and those with small parts, and it can be difficult to determine nuances, such as differentiating a one inch screw from a three-quarters inch screw in a video.

Additionally, consumers sometimes choose to build custom assemblies, as in the case with a computer. In these cases, there may be instructions online, but nothing is specific to ail of the various parts that one can choose to include in the computer build. The majority of the instruction set that comes from any manufacturer is with the motherboard, but since you can include any other manufacturer's components within a computer build, these instructions are quite generic and confusing. As well, many of these instructions are in a foreign language.

Although, the current invention can be used to assist in the assembly, repair and maintenance of any object consisting of pre-manufactured parts, the best use case to understand the concept of the invention is to discuss the frustration of building Ready-to-Assemble (RTA) furniture, such as the kind you typically would find in a store like IKEA®.

When a consumer purchases RTA furniture from an IKEA® or similar store, the consumer will get instructions that, particularly because IKEA® is a worldwide company, will be comprised of panels which usually have diagrams/sketches and only a few words, if any. A consumer may find that he/she may not understand the given instruction set, may have lost the instruction set, may choose not to use the instruction set, or does not understand which pieces the instruction set are referring to.

This poses issues for the consumer, including the following:

1. WOOD—Pieces of wood are sometimes very similar. There may be two similarly sized. and shaped pieces, with their only differentiation being the presence of two holes (to attach another piece to) vs three holes, for example. Or holes on the left side instead of the right.

2. SCREWS—Screws are often very similar. Sometimes two different types of screws have a similar size head (which is difficult to discern from the picture in the instructions) and the screw length may be slightly different.

3. ASSEMBLY—Sometimes it is confusing exactly which side of a piece of wood another piece gets assembled to. It is frustrating to figure out many steps later that the piece has been assembled to the wrong side causing the person to have to undo everything pp to that point.

4. PEOPLE—Some people, even with easy instructions, just have a hard time figuring out how to assemble pieces without additional assistance.

The present invention solves all of these problems by allowing the consumer an interactive experience based on instructions available through a mobile device. It also saves money for the manufacturer or store, in that the consumer doesn't need to contact a support person in the customer service department. It also encourages the consumer to buy these products from the supplier who can provide this mobile platform, as the consumer doesn't have to waste time waiting on the phone for a customer service rep or technical person, or re-do their work because pieces were assembled incorrectly.

### SUMMARY OF THE INVENTION

According to an aspect of the present invention, a method for providing an instruction set to a user for assembling, repairing, or maintaining a manufacturable entity is provided. The method includes utilizing an input device to inspect one or more unassembled parts of the manufacturable entity, recognizing, using the input device, an unassembled part from the one or more unassembled parts, wherein the input device is coupled to an electronic device, determining a correct location and relationship of the recognized unassembled part in relation to one or more of the one or more unassembled parts in a pre-assembled structure, and displaying, on a display, an animation in an augmented reality computing environment demonstrating the relationship between the recognized unassembled part and the one or more unassembled parts, both in regard to each other and to the structure itself.

According to another aspect of the present invention, a system for providing an instruction set to a user for assembling, repairing, or maintaining a manufacturable entity. The system includes an electronic device, the electronic device including an input device (the input device being configured to collect data pertaining to an unassembled part), a graphical user interface (including a display), a memory, and a processor, wherein the processor is configured to inspect one or more unassembled parts of the manufacturable entity, recognize an unassembled part from the one or more unassembled parts, determine a correct location and relationship of the recognized unassembled part in relation to one or more of the one or more unassembled parts in a pre-assembled structure, and display, on the display, an animation in an augmented reality computing environment demonstrating the relationship between the recognized unassembled part and the one or more unassembled parts, both in regard to each other and to the structure itself.

It is an object of the present invention to provide the method for providing an instruction set to a user for assembling, repairing, or maintaining the manufacturable entity, wherein the input device is a camera.

It is an object of the present invention to provide the method for providing an instruction set to a user for assembling, repairing, or maintaining the manufacturable entity, wherein the utilizing further includes capturing an image of the recognized unassembled part.

It is an object of the present invention to provide the method for providing an instruction set to a user for assembling, repairing, or maintaining the manufacturable entity, wherein the recognizing further includes processing the image to determine one or more dimensions and characteristics of the recognized unassembled part.

It is an object of the present invention to provide the method for providing an instruction set to a user for assembling, repairing, or maintaining the manufacturable entity, wherein the displaying further includes visually displaying the one or more dimensions and characteristics of each part identified.

It is an object of the present invention to provide the method far providing an instruction set to a user for assembling, repairing, or maintaining the manufacturable entity, wherein the one or more dimensions and characteristics is selected from the group consisting of an unassembled part name; one or more unassembled part specifications; one or more unassembled part dimensions; one or more specific steps in the instruction set in which the recognized unassembled part appears; and a detailed explanation of how the recognized unassembled part becomes assembled to one or more congruent parts, wherein the detailed explanation includes a text description and a visual animation.

It is an object of the present invention to provide the method fir providing an instruction set to a user for assembling, repairing, or maintaining the manufacturable entity, wherein the recognizing further includes sending the one or more dimensions and characteristics to one or more remote Internet servers.

It is an object of the present invention to provide the method for providing an instruction set to a user for assembling, repairing, or maintaining the manufacturable entity, wherein the recognizing further includes comparing the processed image to entries of related parts in a database.

It is an object of the present invention to provide the method for providing an instruction set to a user for assembling, repairing, or maintaining the manufacturable entity, wherein the recognizing further includes identifying one or more unassembled parts in the image by comparing the one or more unassembled parts in the image to a schematic in an instruction set of manufacturable entity.

It is an object of the present invention to provide the method for providing an instruction set to a user for assembling, repairing, or maintaining the manufacturable entity, wherein the method further includes selecting, using a graphical user interface, the manufacturable entity from a list of possible manufacturable entities.

It is an object of the present invention to provide the system for providing an instruction set to a user for assembling, repairing, or maintaining the manufacturable entity, wherein the input device is a camera.

It is an object of the present invention to provide the system for providing an instruction set to a user for assembling, repairing, or maintaining the manufacturable entity, wherein the camera is further configured to capture an image of the recognized unassembled part.

It is an object of the present invention to provide the system for providing an instruction set to a user for assembling, repairing, or maintaining the manufacturable entity, wherein the processor is further configured to process the image to determine one or more dimensions and characteristics of the recognized unassembled part.

It is an object of the present invention to provide the system for providing an instruction set to a user for assembling, repairing, or maintaining the manufacturable entity, wherein the processor is further configured to visually display, on the display, the one or more dimensions and characteristics of each part identified.

It is an object of the present invention to provide the system for providing an instruction set to a user for assembling, repairing, or maintaining the manufacturable entity, wherein the one or more dimensions and characteristics is selected from the group consisting of an unassembled part name; one or more unassembled part specifications; one or more unassembled part dimensions; one or more specific steps in the instruction set in which the recognized unassembled part appears; and a detailed explanation of how the recognized unassembled part becomes assembled to one or more congruent parts, wherein the detailed explanation includes a text description and a visual animation.

It is an object of the present invention to provide the system for providing an instruction set to a user for assembling, repairing, or maintaining the manufacturable entity, wherein the system further includes one or more remote Internet servers, and wherein processor is further configured to send the one or more dimensions and characteristics to the one or more remote Internet servers.

It is an object of the present invention to provide the system for providing an instruction set to a user for assembling, repairing, or maintaining the manufacturable entity, wherein the processor is further configured to compare the processed image to entries of related parts in a database.

It is an object of the present invention to provide the system for providing an instruction set to a user for assembling, repairing, or maintaining the manufacturable entity, wherein the processor is further configured to identify one or more unassembled parts in the image by comparing the one or more unassembled parts in the image to a schematic in an instruction set of manufacturable entity.

It is an object of the present invention to provide the system for providing an instruction set to a user for assembling, repairing, or maintaining the manufacturable entity, wherein the processor is further configured to select, using the graphical user interface, the manufacturable entity from a list of possible manufacturable entities.

### BRIEF DESCRIPTION OF THE DRAWINGS

FIG. 1 shows a block/flow diagram showing the processes and methods by which the invention identifies the instruction set to be used, according to an embodiment of the present invention.

FIG. 2 shows a block/flow diagram showing the processes and methods by which the invention is utilized to help the user correctly identify pieces, steps and congruent pieces during an assembly build and how the animation or final diagram is displayed, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As described above, there are many issues with the current systems by which users receive instructions for assembling furniture and/or other apparatuses. The present invention solves many of these problems by providing the consumer with an interactive, immersive experience based on instructions available through an electronic device, usually mobile. It also saves money for the manufacturer or store, in that the consumer doesn't need to contact a support person in the customer service department. It also encourages the consumer to buy these products from the supplier who can provide this mobile platform, as the consumer doesn't have to waste time waiting on the phone for a customer service representative or technical person, or re-do their work because pieces were assembled incorrectly.

The present invention also allows the user a flexibility in their preferred style of assembly. A user may choose to follow the written instructions from the beginning and use the invention only when they run into a confusing step, such as not being sure which of two possible screws the instructions may be referring to. Or a user can choose to assemble without written instructions and use the invention to guide them by the animations within the immersive computing environment.

At the same time, the field of immersive computing (e.g. augmented reality, mixed reality, virtual reality) is in its infancy. Although the nascent technology is being more widely adapted and examples are being, seen in which applications are created that are used by everyday consumers (such as the worldwide “Pokémon Go” phenomenon in 2016), immersive computing applications are mostly being used for gaming concepts. The current invention is meant to use the burgeoning technology of immersive computing in a way that helps people in their lives and not just for gaining.

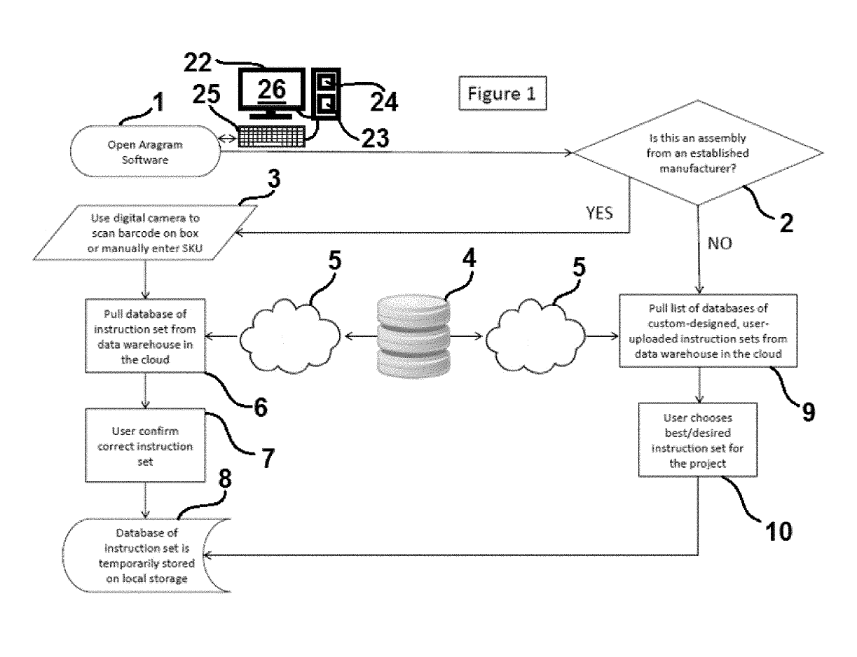

According to an embodiment, a user would begin to use the preset invention when building a pre-assembled object made up of pre-manufactured pieces and connectors and may find that he/she may not understand the given instruction set, may have lost the instruction set, may choose not to use the instruction set or does not understand which pieces the instruction set are referring to. This leads to what is likely to be the first interaction with the invention that a user would perform which is demonstrated in FIG. 1.

Referring now to FIG. 1, a block/flow diagram showing the processes and methods by which a user of the present invention identifies the pre-assembled object that the user is looking for help to build is illustratively depicted, in accordance with an embodiment of the present invention.

According to an embodiment, one or more instruction sets are stored in a stored database. Each of these instruction sets pertains to a specific apparatus and/or method. According to an embodiment, the user identifies what he/she is building so that the invention can determine which instruction set to retrieve from the stored databases.

At step (1), the user opens a digital application on an electronic device 22 such as, e.g., a desktop computer, a laptop computer, a tablet computer, a smartphone and/or any other suitable. electronic device. According to an embodiment, the electronic device includes at least one processor 23 and memory 24. According, to an embodiment, the electronic device includes one or more graphical user interfaces 25, which may include one or more displays 26. According to an embodiment, the processor 23 may perform one or more steps of the present invention. According to an embodiment, the application includes software. According to an embodiment, the software has to be downloaded to the electronic device and/or accessed through the Internet on the electronic device. According to an embodiment, opening the application includes logging into the application.

At step (2), after logging in, the application asks the user if the project that the user is looking to assemble is from an established manufacturer, such as a manufacturer that a user would commonly find at a common store, such as IKEA®.

If the user answers yes, by performing manual selection gestures in using his/her finger on the electronic device's touch screen, by typing into the electronic device's keyboard at a prompt, by using a voice command to indicate the affirmative that would be captured by the sound receiver within the electronic device, and/or by any other suitable means, the user, at step (3) is prompted to indicate the object the user is trying to build. According to warn embodiment, the user may make said indication by scanning a barcode on the object's box as supplied by the manufacturer, manually typing in the object's SKU code, manually selecting from a series of dropdown prompts requesting manufacturer name, object category and object name and model number, and/or by any other suitable identifying means.

According to an embodiment, after the information from step (3) is received, indicating what the user is trying to build, the software, at step (6), pulls the database of the instruction set from the stored database on servers (4) in the cloud (5) that are accessible with a connection to the Internet.

According to an embodiment, at step (7) the application displays, on a display coupled to the electronic device, the instruction set on the visible screen of the user's electronic device and prompts the user to indicate and confirm if it is the correct instruction set that corresponds to the correct item/project that the user intends to build.

According to an embodiment, when it is determined that the instruction set corresponds correctly with the user's project, at step (8), a copy of the instruction set and its underlying database is stored on the local electronic device of the user for the current project build, This enables the user to refer back to it at a later date for repairs or maintenance.

According to an embodiment, when the user, at step (2) is asked if the project that the user is looking to assemble is from an established manufacturer, the user may answer no, by performing manual selection gestures in using his/her finger on the electronic device's touch screen, by typing into the electronic device's keyboard at a prompt, by using a voice command indicate the negative that would be captured by the sound receiver within the electronic device, and or by any other suitable means.

If the user answers the prompt of step (2) in the negative, then, at step (9), the software pulls a list of possible projects that the user may be interested in building from a database warehouse that holds all custom-designed, user-uploaded instruction sets from the stored database on servers (4) in the cloud (5), accessible with a connection to the Internet.

The user then, at step (10), chooses, from the list of custom-designed, user-uploaded instruction sets, the one instruction set that best fits the user's desire to build for the project. Once an instruction set is selected from this list, a copy of the instruction set and its underlying database will be stored, at step (8), on the local electronic device of the user for the current project build. This enables the user to refer back to it at a later date for repairs or maintenance.

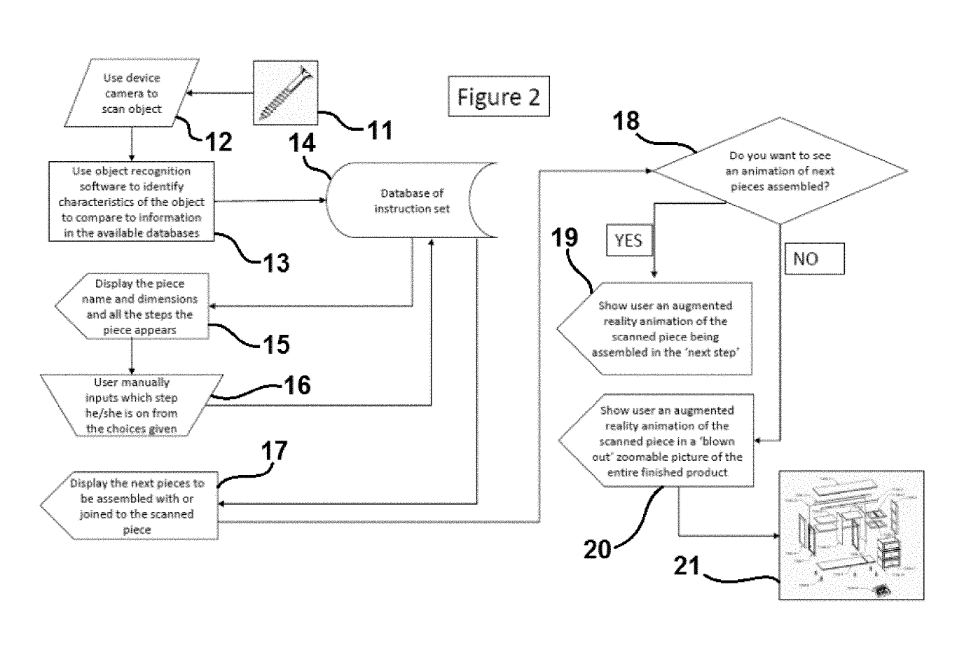

Following step (8), the user has indicated the proper instruction set that the user wants the present invention to help work with. Referring now to FIG. 2, a block/flow diagram showing the processes and methods used by the present invention assist the user in building his/her assembly is illustratively depicted, in accordance with an embodiment of the present invention.

With the database of instruction sets (14) now stored locally on the electronic device as seen in (8) of FIG. 1, the present invention has a database of information to compare the pieces and connectors of the project.

According to an embodiment, at step (12), the user starts by using a camera coupled to the electronic device to scan the object (11) (e.g., a screw or connector). It is noted, however, that the object (11) could be a wood piece, a bracket, a wheel and/or any number of pieces contained in a pre-assembled project.

At step (13), the application uses object recognition software to create a digital profile and characteristic set of the object that it uses to compare to the information in the database of the stored instruction set (14). From that digital profile and characteristic set, it determines which piece or connector the scanned object is within the limits of the only possible pieces and connectors that are contained within the parameters of the instruction set.

Once the invention determines, at step (13), the correct piece and identities its name, dimensions, and/or other identifiable characteristics tom the information in the database (14), the application, at step (15), displays this identifying information on the electronic device's display. The invention also is able to determine from the information in the database (14) which steps in the published instruction set that the identified piece or connector belongs in. If it is only relevant in one step of the instruction set, it will just display to the user the number that corresponds to that one step for confirmation. Otherwise, it will display to the user all numbers of all the steps that the piece or connector might apply to and, at step (16), prompt the user to select which step of the instruction set he/she is working on. The user can, at step (16). indicate which step he/she is currently working on by performing manual selection gestures in using his/her finger on the electronic device's touch screen, by typing into the electronic device's keyboard at a prompt, by using a voice command to indicate the selection that would be captured by the sound receiver within the electronic device, and/or by any other suitable means.

When the user indicates, at step (16), which step from a selection of probable steps in the instruction set, the invention determines, through accessing the database (14) of the instruction set, what the next pieces or connectors would be assembled to the piece or connector that had been optically scanned and recognized as described above. At step (1), the application displays, on the electronic device's display, the next pieces to which the optically scanned piece should be connected. According to an embodiment, at this point, the application has all the information it needs to continue helping the user with the originally scanned object, namely, the original piece name, dimensions, characteristics and animated view as well as the next pieces or connectors and its name, dimensions, characteristics and animated view, which it has pulled from the database (14).

At step (18), the user is prompted if he/she needs to see an animation of the pieces and connectors in question coming together. If the answer is indicated in the affirmative, the invention will, at step (19), display, on the user's electronic device's display, an animation of the multiple pieces or connectors coming together based on which pieces are in the step, which step in the instruction set it is, and the very limited possibilities of how many potential different ways things in a pre-assembled object can be assembled together.

When the user, at step (18), is prompted if he/she needs to see an animation of the pieces and connectors in question corning together, and the user indicates in the negative, the application, at step (20), displays an augmented reality animation of the scanned piece and its place in a ‘blown out’ or ‘exploded’ view (21) of the entire finished piece so the user has reference to where the scanned piece or connector belongs within the context of the entire assembly.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may, be connected to and/or communicate with entities such as, but not limited to: one or more users from user input devices; peripheral devices; an optional cryptographic processor device; and/or a communications network. For example, the present invention may be connected to and/or communicate with users, operating client device(s) including, but not limited to, personal computers), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or thrillers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-P89800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systernizations peripheral devices, and/or the like. Of course, any of the above components may be connected directly to one another, connected to the CPU, and/or organized in numerous variations employed as exemplified by various computer systems

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself, internal memory may include, but is not limited to: fist registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's .Athlon, Duron and/or Opteron; ARM's application, embedded and secure processors; IBM and/or Motorola's DragonBall and PowerPC; IBM's and Sony's Cell processor; Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g. via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the loss cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed b the system designer/administrator of the present invention, somewhat like a one-chip programmable breadboard. An FPGAs logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory In some circumstances, the present invention may be developed on regular FPGAs and then migrated into a fixed version. that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” far the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture. through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture. ((E)ISA), Micro Channel Architecture (MCA), NuBus, Peripheral Component Interconnect (Extended) (PCI(X)) PCI Express, Personal Computer Memory Card International Association (PCMCIA) and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB), infrared; joystick; keyboard; midi; optical; PC AT; PS/2, parallel; radio; video interface; Apple Desktop Connector (ADC), BNC, coaxial, component, composite, digital, Digital Visual Interface (DVI), high-definition multimedia interface (HDMI), RCA, RE antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (VSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents. as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's SafeNet's Luna PCI (e.g., 7100) series; Semaphore Communications' 40 MHz Roadrunner 184; Sun's Cryptographic. Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the. operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft. Windows 2000/2003/3.1.195/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system. may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C(++), C# and/or .NET, Common Gateway Interface (CGI) scripts, dynamic (P) hypertext markup language (HTML), FLASH, Java, JavaScript, Practical Extraction Report Language (PERL), Hypertext Pre-Processor (PHP), pipes, Python, wireless application protocol (WAP), WebObjects, and/,or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM) Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn farther parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP, Vista/7 (i.e., Aero), Unix's X-Windows (e.g., which may include additional Unix graphic interface libraries and layers such as K Desktop Environment (KDE), mythTV and GNU Network Object. Model Environment (GNOME)), web interface libraries e.g., ActiveX, AJAX, (D)HTML, FLASH, Java, JavaScript, etc. interface libraries such as, but not limited to, Dojo, jQuery(UI), MooTools Prototype script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, ardor atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext dewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like .from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft. Exchange, and/or the like. The mail server may allow for the execution of program components through facilities such as ASP, ActiveX, (ANSI) (Objective−) C (++), C# and/or .NET, CGI scripts, Java, JavaScript PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component system, user and/or data communications, requests, information, and/or responses.

Mail Client

A mail client component is a stored program component that is executed by a CPU. The mail client may be a conventional mail viewing application such as Apple Mail, Microsoft

Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and: or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (POP)) encryption and/or decryption. The cryptographic component may employ cryptographic techniques such as, but not limited to: digital certificates: (e.g., X.509 authentication framework), digital signatures, dual signatures, enveloping, password access protection public key management, and/or the like. The cryptographic component will facilitate numerous (encryption and/or decryption) security protocols such as, but not limited to: checksum Data Encryption Standard (DES), Elliptical curve Encryption (ECC), International Data Encryption Algorithm (IDEA), Message Digest 5 (MD5, which is a one way hash function), passwords, Rivest Cipher (RCS), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its. stored data,. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows. the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an :array, hash, (linked) list, struct, structured text file (e.g.,. XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases v the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name app_type, OS_compatibilities_list, version, timestamp, developer_ID, and/or the like. A beverages table including, for example, heat capacities and other useful parameters of different beverages, such as depending on size beverage_name, beverage_size, desired_coolingtemp, cooling_time, favorite_drinker, number_of_beverages, current_beverage_temperature, current_{—} ambient_temperature, and/or the like. A Parameter table may include fields including the foregoing fields, or additional ones such as cool_start_time, cool_preset, cooling_rate, and/or the like. A Cool Routines table may include a plurality of cooling sequences may include fields such as, but not limited to: sequence_type, sequence_id, flow_rate, avg_water_temp, cooling_time, pump_setting, pump_speed, pump_pressure, power _level, temperature_sensor_id_number, temperature_sensor_location, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularly, it is to be understood that the present disclosure has been made only by way of illustration and that numerous changes in the details of construction and arrangement of parts may be resorted to without departing from the spirit mud the scope of the invention.

What is claimed is:

1. A method for providing an instruction set to a user for assembling, repairing, or maintaining a manufacturable entity, the method comprising:
utilizing an input device to inspect one or more unassembled parts of the manufacturable entity;
recognizing, using the input device, an unassembled part from the one or more unassembled parts,
wherein the input device is coupled to an electronic device;
determining a correct location and relationship of the recognized unassembled part in relation to one or more of the one or more unassembled parts in a pre-assembled structure; and
displaying, on a display, an animation in an augmented reality computing environment demonstrating the relationship between the recognized unassembled part and the one or more unassembled parts, both in regard to each other and to the structure itself.

2. The method as recited in claim 1, wherein the input device is a camera.

3. The method as recited in claim 2, wherein the utilizing further includes:
capturing an image of the recognized unassembled part.

4. The method as recited in claim 3, wherein the recognizing further includes:
processing the image to determine one or more dimensions and characteristics of the recognized unassembled part.

5. The method as recited in claim 4, wherein the displaying further includes:
visually displaying the one or more dimensions and characteristics of each part identified.

6. The method as recited in claim 5, wherein the one or more dimensions and characteristics is selected from the group consisting of:
an unassembled part name; one or more unassembled part specifications; one or more unassembled part dimensions; one or more specific steps in the instruction set in which the recognized unassembled part appears; and a detailed explanation of how the recognized unassembled part becomes assembled to one or more congruent parts, wherein the detailed explanation includes a text description and a visual animation.

7. The method as recited in claim 4, wherein the recognizing farther includes:
sending the one or more dimensions and characteristics to one or more remote Internet servers.

8. The method as recited in claim 4, wherein the recognizing farther includes:
comparing the processed image to entries of related parts in a database.

9. The method as recited in claim 3, wherein the recognizing further includes:
identifying one or more unassembled parts in the image by comparing the one or more unassembled parts in the image to a schematic in an instruction set of manufacturable entity.

10. The method as recited in claim 1, further comprising:
selecting, using a graphical user interface, the manufacturable entity from a list of possible manufacturable entities.

11. A system for providing an instruction set to a user for assembling, repairing, or maintaining a manufacturable entity, the system comprising:
an electronic device, the electronic device including:
an input device, the input device configured:
to collect data pertaining to an unassembled part;
a graphical user interface, including a display;
a memory; and
a processor, the processor configured to:
inspect one or more unassembled parts of the manufacturable entity;
recognize an unassembled part from the one or more unassembled parts;
determine a correct location and relationship of the recognized unassembled part in relation to one or more of the one or more unassembled parts in a pre-assembled structure; and
display, on the display, an animation in an augmented reality computing environment demonstrating the relationship between the recognized unassembled part and the one or more unassembled parts, both in regard to each other and to the structure itself.

12. The system as recited in claim 11, wherein the input device is a camera.

13. The system as recited in claim 12, wherein the camera is further configured to:
capture an image of the recognized unassembled part.

14. The system as recited in claim 13, wherein the processor is further configured to:
process the image to determine one or more dimensions and characteristics of the recognized unassembled part.

15. The system as recited in claim 14, wherein the processor is further configured to:
visually display, on the display, the one or more dimensions and characteristics of each part identified.

16. The system as recited in claim 15, wherein the one or more dimensions and characteristics is selected from the group consisting of:
an unassembled part name; one or more unassembled part specifications; one or more unassembled part dimensions; one or more specific steps in the instruction set in which the recognized unassembled part appears; and a detailed explanation of how the recognized unassembled part becomes assembled to one or more congruent parts, wherein the detailed explanation includes a text description and a visual animation.

17. The system as recited in claim 14, further comprising:
one or more remote Internet servers, and
wherein processor is further configured to:
send the one or more dimensions and characteristics to the one or more remote Internet servers.

18. The system as recited in claim 14, wherein the processor is further configured to:
compare the processed image to entries of related parts in a database.

19. The system as recited in claim 13, wherein the processor is further configured to:
identify one or more unassembled parts in the image by comparing the one or more unassembled parts in the image to a schematic in an instruction set of manufacturable entity.

70. The system as recited in claim 11, wherein the processor is further configured to:
select, using the graphical user interface, the manufacturable entity from a list of possible manufacturable entities.
